(19) United States
(12) Patent Application Publication
(10) Pub. No.: US 2003/0146235 A1
(43) Pub. Date: Aug. 7, 2003

(54) Drive-up vending system

(76) Inventor: Harvey S. Peeler JR., Gaffney, SC (US)

Correspondence Address: DORITY & MANNING, P.A., POST OFFICE BOX 1449, GREENVILLE, SC, 29602-1449, US

(21) Appl. No.: 10/348,048

(22) Filed: Jan. 21, 2003

Related U.S. Application Data
(60) Provisional application No. 60/352,376, filed on Jan. 28, 2002.

(51) Int. Cl. B65H 3/44; B65G 59/00; B65H 1/00

(52) U.S. Cl. 221/123; 221/129; 221/131; 221/133

(57) ABSTRACT

A vending system is disclosed suitable for providing beverage products to consumers. In particular, the vending system is accessible to consumers from a vehicle. The vending system is well suited for providing beverages to consumers in multi-use sized containers, such as half-gallon or gallon sized containers. In one particular embodiment, the system can provide a variety of dairy products, such as a variety of milk products, to consumers. The vending system may be a freestanding, self-enclosed system which may be conveniently located in a parking lot.

### RELATED APPLICATION

The present Utility Application is based on a Provisional Application filed Jan. 28, 2002, having U.S. Application No. 60/352,376.

### BACKGROUND OF THE INVENTION

In this hectic day and age, time has become a very valuable commodity. Busy people are continuously rushed between work and home, attempting to run a multitude of errands in a short amount of time. One of the most common errands which must be completed is that of picking up some milk at the store on the way home. This seemingly innocent need can lead to timely delays in the day's schedule when parking, shopping, and waiting in line to pay for a single item is included in the “quick” stop. This process can take even longer when a consumer is running errands with small children in tow. A drive-through system which could prevent such delays may be preferred by many consumers.

Vending machines for small items, such as snack foods, for example, have been known for decades. These machines are commonly located in offices, hotels, schools, and the like, where consumers can walk up and deposit their money to obtain some desired selection of food and/or drink. However, these machines are usually located for access to pedestrians alone and are not amenable to direct access from an automobile. Additionally, the selection of food and drink available from such machines tends to be limited to snack foods or single meal items, such as a single sandwich selection, for example.

As such, a need currently exists for a vending system which can deliver larger sized items, such as multi-use sized containers, for example. In addition, a need exists for these vending systems to be sized and located to provide for the possibility of drive-through service, allowing purchases of larger items directly from a vehicle without requiring parking in a lot and shopping inside a store.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying figures, in which:

FIG. 1 is a perspective view of a portion of the interior of one embodiment of a vending system of the present invention;

FIG. 2 is a view of one embodiment of an interactive panel located at the front of the vending system of FIG. 1;

FIG. 3 is a sectional view of one embodiment of a product delivery door of the system of the present invention;

FIG. 4 is a top view of an embodiment of a product delivery door of the system of the present invention; and

FIG. 5 is a sectional view of another embodiment of a product delivery door of the system of the present invention.

Repeat use of reference characters in the present specification and drawings is intended to represent same or analogous features or elements of the present invention.

### DETAILED DESCRIPTION OF PREFERRED EMBODIMENTS

Reference will now be made in detail to various embodiments of the invention, one or more examples of which are set forth below. Each embodiment is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention cover such modifications and variations as come within the scope of the appended claims and their equivalents.

In general, the present invention is directed to a system for vending products to consumers. More specifically, the vending system of the present invention can deliver beverages in large containers, such as multi-use sized containers, to a consumer in a convenient location. For instance, the vending system may be accessible to a consumer directly from a vehicle. In one embodiment, the system may be a drive-up beverage vending system located in a parking lot.

In general, when utilizing the vending system of the present invention, a customer can approach the front of the machine and access an interactive panel located on the machine. At the interactive panel, the purchaser can engage the vending system through selection of the desired items from one or more choices displayed on the panel and may pay for the selection using any of a variety of payment methods such as, for example, cash, debit card, credit card, food stamp card, etc. Upon payment, the machine can deliver the selection to a product delivery door, where the purchaser can retrieve the product(s).

The vending system of the present invention is well suited for sales of beverage products in multi-use sized containers. The term ‘multi-use sized containers’ is herein defined to mean containers the contents of which may be consumed piecemeal over a period of time. For example, certain beverages, such as milk, egg nog, juice, soda, and the like, are commonly sold in liter, quart, half-gallon, two liter, gallon, or even larger sized containers for consumption one serving at a time. As such, these container sizes may be considered examples of multi-use sized containers. However, multi-use sized containers are not limited to these sizes. Other sizes of containers, larger sized containers, and even smaller sized containers may also be considered multi-use sized containers within the definition of the present disclosure. For example, other beverage products, such as cream and half-and-half, for example, may be sold in smaller containers, such as pint-sized containers, and the contents of such are generally consumed piecemeal over a period of time. Thus smaller containers may, in some embodiments of the present invention, also be considered to be multi-use sized containers.

The present invention is generally directed to the sale of dairy products, however other beverages are also contemplated within the scope of the present system. In addition to or alternatively to milk, for example, juice, soda, or other beverages could be sold using the presently disclosed system.

The vending system of the present invention may be utilized for the sale of any combination of multi-use sized containers. For example, the vending system can be used to sell a variety of different products in a variety of differently sized containers. For instance, in one embodiment, the vending system can offer a variety of product choices such as, for example, whole milk, 2% milk, 1% milk, ½% milk, skim milk, chocolate milk, soy milk, egg nog, cream, half-and-half, fruit juices, sodas, or any other alternative. Moreover, the system can provide products in a variety of container sizes. For example, whole milk may be offered in both a gallon container and a half-gallon container, while skim milk may be offered in a half-gallon container and a quart container. Countless combinations of products and container sizes could be offered to the consumer by the vending system of the present invention.

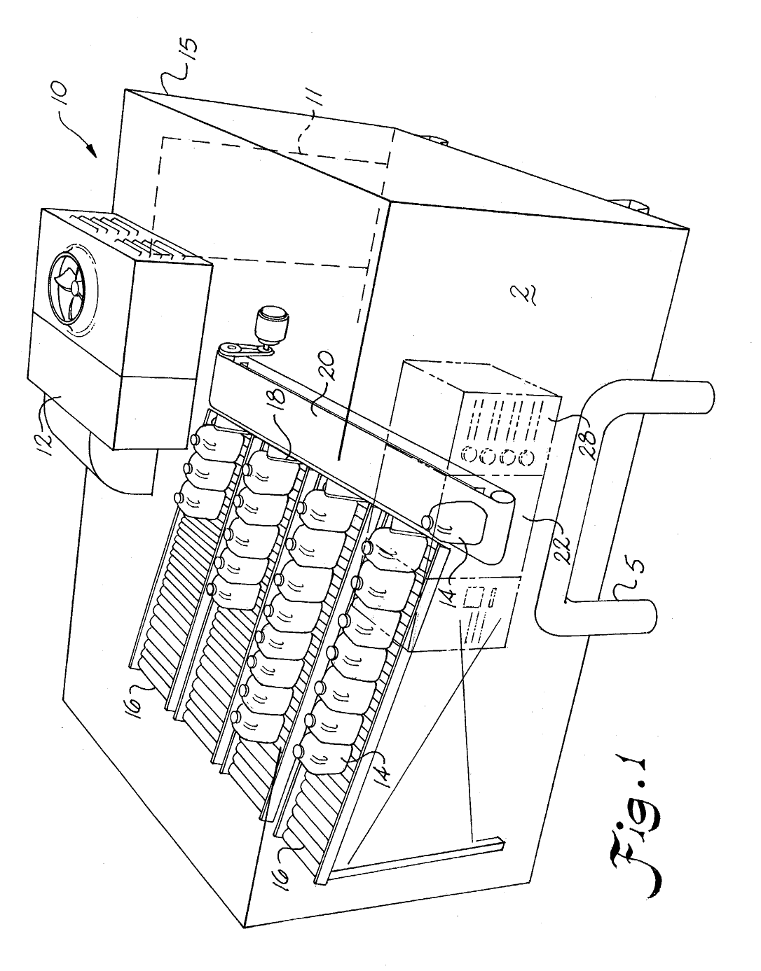

FIG. 1 illustrates one embodiment of the present vending system 10. In this particular embodiment, the vending system 10 includes a freestanding structure 15 and a temperature control unit 12. In other embodiments, the system may not include freestanding structure 15, but may be rather combined with, attached to, or built into a secondary structure. The temperature control unit 12 can be any suitable unit as is generally known in the art and may keep the products 14 within a desired temperature range prior to purchase. In general, the interior of structure 15 can be refrigerated or heated, depending upon the exterior temperature, such that the products 14 held within the structure 15 are maintained within a desired temperature range. For example, in one embodiment, the interior of structure 15 can be maintained between about 32° F. and about 40° F. In one embodiment, the interior of structure 15 can be maintained at approximately 35° F.

The overall size of freestanding structure 15 can vary depending upon location, expected restocking requirements, etc. In one embodiment, structure 15 can be of a size so as to be easily visible and accessible to vehicles, and yet still be small enough to fit into smaller access areas. For example, in one embodiment, freestanding structure 15 can have interior dimensions of about 8 feet in width by about 12 feet in length by about 8 feet in height. At such a size, freestanding structure 15 may take up roughly the space of an urban area parking space and may be conveniently located in a wide variety of places easily accessible to vehicles. For example, the vending system of the present invention may be located in or near a post office parking lot, a bank parking lot, or in any other location which may be convenient for consumers. Moreover, the exterior of structure 15 may include decorations, advertisements, or product designs as desired. Structure 15 can also include an access 11, such as a door or a window, somewhere on the perimeter of structure 15. Access 11 can allow entry to the interior of structure 15 for restocking of product, restocking of cash for making change, purchase money retrieval, cleaning, maintenance, etc.

In order to purchase a product from the vending system 10 of the present invention, a purchaser can approach the front 2 of the structure 15. For example, a purchaser may approach the structure in a car, a truck, a motorcycle, a bicycle, or by foot. In certain embodiments, vending system 10 may include protective barrier 5 to protect structure 15 from approaching vehicles. In one particular embodiment, the purchaser may engage vending system 10 through the window of a vehicle. In general, a purchaser may engage vending system 10 at an interactive panel 28 on the front 2 of structure 15.

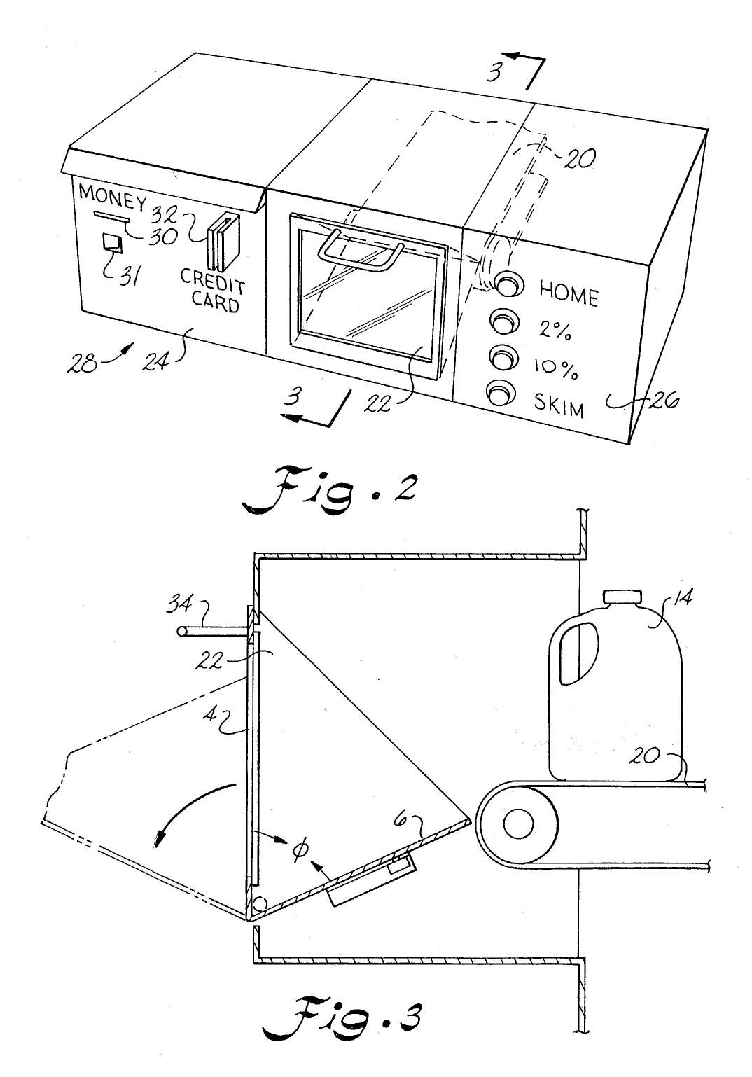

FIG. 2 illustrates one possible embodiment of a portion of the front 2 of structure 15 including an interactive panel 28. In one embodiment, interactive panel 28 can be located so as to allow easy access from the window of a vehicle. After a vehicle comes to a stop adjacent to protective barrier 5, the driver can simply reach out of the window to access the interactive panel 28. At the interactive panel 28, the customer can make a product selection from the product selection area 26, pay for the selection at a payment area 24, and remove the desired selection from the product delivery door 22.

The product selection area 26 of the interactive panel 28 can, in one embodiment, include buttons and labels listing various product choices, as shown in FIG. 2. In an alternative embodiment, the product selection area can include a display screen, and can utilize an interactive choice system including an LCD screen. The interactive system may be programmed to display various images on the screen including, for example, operating instructions, product selections, payment instruction, etc. which can appear in sequence upon proper customer response. The customer may respond to the prompts on the screen with touch screen responses or button punch responses, as desired.

In conjunction with a customer making a product selection, payment can be made at the payment section 24 of the interactive panel 28. Payment section 24 can include, for example, cash intake slot 30, change return slot 31, and card slot 32 which can be programmed to accept various debit cards, credit cards, food stamp cards, and the like. Payment section 24 can be connected to product selection area 26 and any necessary exterior banking information to provide for proper handling of the transaction.

After a product has been selected and paid for at interactive panel 28, the selected product can be automatically moved via a product delivery path from a storage location in the interior of the structure 15 to product delivery door 22 to be removed by the purchaser. The product delivery path of the system may generally stretch from the storage location of the product to the final destination of the delivery door 22 and can include any routing of the product therebetween. For example, as illustrated in FIG. 1, after a product 14 is selected and paid for at the interactive panel 28, gate 18 can open, allowing product 14 to move from its storage location on conveyor 16, down conveyor 16 and onto conveyor 20 through gate 18. Product 14 can then proceed down the path of conveyor 20 to product delivery door 22, where the consumer can remove it from the machine.

Generally, plastic gallon-sized containers are illustrated in the figures. This is not a requirement of the system, however, and the vending system of the present invention could alternatively have some or all of the product conveyors 16 sized to hold and deliver alternative sizes or shapes of containers. As discussed above, the vending system of the present invention may be used to deliver beverages in any multi-use sized container.

Referring again to FIG. 1, vending system 10 can include at least one product conveyor 16, each of which can hold and store a row of product 14 prior to purchase. Though illustrated in FIG. 1 in a substantially horizontal arrangement, in an alternative embodiment, product conveyor 16, may hold a row of product 14 in a more vertical alignment. In one embodiment, vending system 10 may include about 12 different product conveyors 16 each of a length to hold about 12 standard plastic gallon containers. Smaller or larger systems can also be manufactured which can hold more or less product.

In the embodiment illustrated in FIG. 1, product conveyor 16 can hold a row of product 14 for ultimate delivery to the consumer at the front of the machine. In general, a single product conveyor 16 can be any type of a conveyor which, upon engagement of the system 10, may define at least a portion of the delivery path for the product 14 from storage in the interior of structure 15 to delivery door 22 where the purchaser can retrieve the product 14. In one embodiment of the invention, a single product conveyor can provide the entire delivery path of the product from storage location to delivery location. Alternatively, the complete delivery path of the product from storage location to delivery location can include product travel along two, three, or even more different conveyors in sequence.

Product conveyor 16 can be any sort of a conveyance line which can either hold or move product, as required. For example, as illustrated in FIG. 1, product conveyor 16 can include a series of rollers placed on a slight incline which can allow container 14 to be gravity fed off of the lower end of product conveyor 16 onto the surface of intersecting conveyor 20 when that particular product has been selected for purchase. Any other suitable conveyor type can also be utilized for product conveyor 16, however. For example, in an alternative embodiment, product conveyor 16 can be a stationary slide which can include a surface having relatively low surface friction such that product 14 can simply slide down product conveyor 16 in the direction of conveyor 20 as needed. Alternatively, product conveyor 16 can be a motor driven conveyor which can engage and move when a product 14 stored on that product conveyor 16 has been selected by a consumer.

In one embodiment, at one end of product conveyor 16 can be a gate or closure 18, such as, for example, a spring-loaded closure. Closure 18 can prevent product 14 from moving onto conveyor 20 prior to selection of that product by a consumer. This can be particularly desirable in those embodiments wherein product 14 is gravity fed from product conveyor 16 to conveyor 20. In certain embodiments, however, closure 18 may not be necessary. For example, when product conveyor 16 is a motor driven conveyor, the motor controlling product conveyor 16 can be programmed to stop conveyor motion after a single product has passed from product conveyor 16 to conveyor 20, such that closure 18 is not necessary to prevent excess product motion.

After leaving product conveyor 16, product 14 can move onto conveyor 20. Conveyor 20 can be any suitable form of conveyance line. Conveyor 20 can be, for example, a motor-driven endless traveling conveyor which is aligned to intersect the path of each product conveyor 16 successively. Alternatively, conveyor 20 can be a gravity fed conveyor, such as a series of rollers or a low friction slide arrangement. Moreover, conveyor 20 can be the same or different style of conveyor as product conveyor 16. Conveyor 20 can provide a portion of the delivery path for carrying product 14 from the storage location to the product delivery door 22. In one embodiment, conveyor 20 can form the terminal portion of the delivery path for delivering the product 14 from the interior of the vending system 10 to a location where the purchaser can retrieve the product at delivery door 22.

In general, the product delivery door of the present invention can be any suitable door which can allow the purchaser of the product access to retrieve their purchase. A wide variety of possible vending system doors are known in the art, many of which could be properly sized so as to be suitable for use in the system of the present invention.

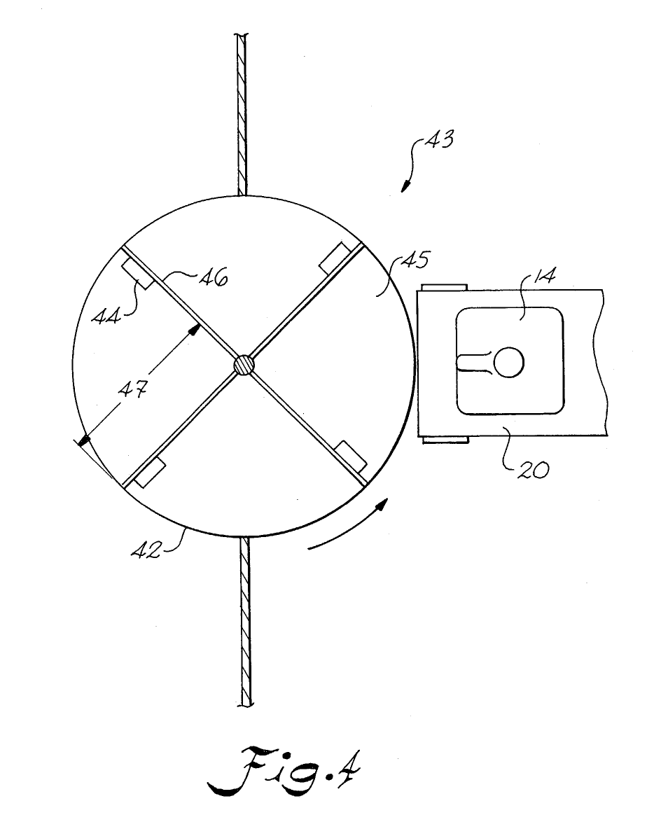

One embodiment of product delivery door 22 can be seen in the cut-away view illustrated in FIG. 3. As can be seen, product delivery door 22 can be an automatic sealing delivery door including front panel 4 and back panel 6 set at an angle Φ to each other. In this embodiment, as product 14 approaches product delivery door 22, product 14 can slide off of conveyor 20 and be held in between the front panel 4 and back panel 6 of product delivery door 22. Product delivery door 22 can include handle 34. When door 22 is opened using handle 34 the product 14 can lie on the front panel 4 of door 22 and the purchaser can take the product 14. While product delivery door 22 is open, the back panel 6 of door 22 can effectively block access to the machine interior through door 22. Angle Φ can be any suitable angle which can allow door 22 to cradle product 14, and can provide access to product 14 by the purchaser when the door 22 is open while substantially blocking access to the interior of the machine with back panel 6 of door 22 at the same time. For example, angle Φ can be between about 50° and about 80°. In one embodiment, angle Φ can be about 65°.

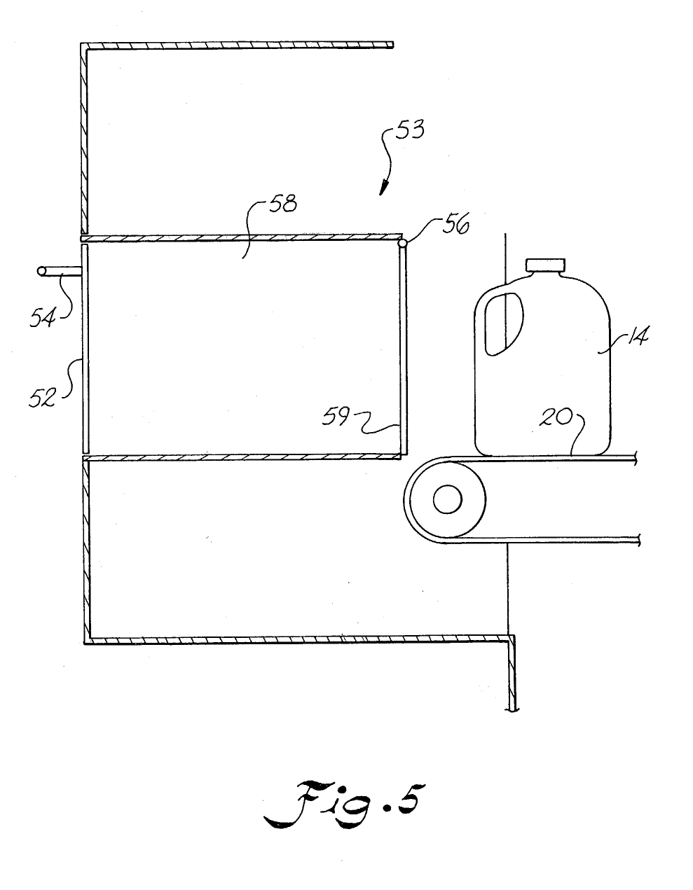

In an alternative embodiment, the product delivery door can be a revolving door, one embodiment of which is illustrated in FIG. 4 in a top view. As can be seen, as product 14 moves to the end of conveyor 20, it can move onto the circular base 42 of door 43. Door 43 can be divided into separate sections 45 by two or more panels 46. Each door panel 46 can have a width 47 extending from the center of rotating door 43 to the outer edge of circular base 42 and a height greater than that of product 14. Panels 46 can be set at an angle to each other such that product 14 can move off of conveyor 20 and completely fit into one of the door sections 45. Each panel 46 can also include a handle 44 to allow a purchaser to manually pivot the door and bring the door section 45 which contains the product they have purchased to the front of door 43 so that they may retrieve the product. Alternatively, the door can be motor driven, and the door can automatically pivot and bring product 14 to the front of door 43 after the product has entered a door section 45. In either case, door 43 can be formed so as to limit access to the interior of the machine. For example, in one embodiment, door 43 can include a locking system which prevents rotation of base 42 other than when a product is being retrieved. In another embodiment, panels 46 can be placed on base 42 so as to physically limit access to the machine interior. Various restrictive devices could also be included, such as restrictive gates, to prevent access to the interior of the machine through door 43.

Yet another possible alternative embodiment for a product delivery door in the vending system of the present invention is illustrated in FIG. 5. Door 53, as illustrated in FIG. 5, includes chamber 58 which can be enclosed by solid walls on four sides and movable panels on two sides. For example, chamber 58 can include panel 59 at one end of chamber 58 and at panel 52 at the opposite end of chamber 58. In one embodiment, panel 59 can be a swinging panel such that as product 14 leaves conveyor 20 it has enough momentum to be carried through panel 59 and into chamber 58. Panel 52 cap be located at the front of the vending system on the interactive panel and equipped with a handle 54. After product 14 has entered chamber 58, a purchaser can open panel 52 and retrieve product 14. Panel 59 need not be located opposite panel 52 in chamber 58, however. In alternative embodiment, panel 59 may be located on the top of chamber 58, such that product 14 drops into chamber 58 from above, or may alternatively be in one of the sides of chamber 58, such that product 14 enters chamber 58 from the side and exits out the front at panel 52.

As with other possible alternatives for the construction of the product delivery door, door 53 can be formed so as to limit access to the machine interior through the door. For example, panel 59 and panel 52 could be linked together in a locking mechanism, such that when one panel is unlocked the other is locked. Alternatively, panel 59 can be attached to chamber 58 with a one-way hinge 56, which can prevent panel 59 from opening in the direction of the machine interior. Also, chamber 58 can be constructed with suitable distance between panels 59 and 52 so as to cause attempted physical access beyond panel 59 to be very difficult. As with other door embodiments, door 53 can include a combination of various different restrictive devices.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A vending system comprising:
a storage location for storing a product comprising a beverage in a multi-use sized container;
a product delivery path along which the multi-use sized container can move; and
an interactive panel, said interactive panel comprising a product selection area, a payment area, and a product delivery door, said interactive panel being accessible to a person seated in a motor vehicle; wherein the product delivery path commences at the storage location and terminates at the product delivery door.

1. The vending system of claim 1, wherein the beverage comprises a dairy product.

2. The vending system of claim 1, comprising two or more storage locations for separately storing two or more different products,

3. The vending system of claim 2, wherein each of said two or more different products comprise a beverage in a multi-use sized container.

4. The vending system of claim 2, wherein said two or more different products comprise different dairy products.

5. The vending system of claim 4, wherein the dairy products are selected from the group consisting of whole milk, 2% milk, 1% milk, ½% milk, and skim milk.

6. The vending system of claim 4, wherein said different products further comprise fruit juice products.

7. The vending system of claim 2, wherein the two or more storage locations are of a size to store the same multi-use sized container.

8. The vending system of claim 2, wherein the two or more storage locations are of a size to store different multi-used sized containers.

9. The vending system of claim 1, wherein the multi-use sized container is selected from the group consisting of a gallon container, a half gallon container, and a quart container.

10. The vending system of claim 1, wherein at least a portion of the product delivery path is gravity fed.

11. The vending system of claim 1, further comprising a freestanding structure enclosing the storage location and the product delivery path.

12. The vending system of claim 11, wherein the freestanding structure is in parking lot.

13. The vending system of claim 1, wherein the product delivery path comprises two or more product conveyors.

14. A vending system comprising:
two or more storage locations for separately storing two or more different products, each of said different products comprising a beverage, at least one of said different products comprising milk in a multi-use sized container;
a product delivery path along which the multi-use sized container can move; and
an interactive panel, said interactive panel comprising a product selection area, a payment area, and a product delivery door, said interactive panel being accessible to a person seated in a motor vehicle; wherein the product delivery path commences at the storage location and terminates at the product delivery door.

15. The vending system of claim 14, wherein said two or more different products comprise different dairy products.

16. The vending system of claim 14, wherein the milk is selected from the group consisting of whole milk, 2% milk, 1% milk, ½% milk, and skim milk.

17. The vending system of claim 14, said two or more different products further comprising fruit juice products.

18. The vending system of claim 14, wherein the two or more storage locations are of a size to store the same multi-use sized container.

19. The vending system of claim 14, wherein the two or more storage locations are of a size to store different multi-used sized containers.

20. The vending system of claim 14, wherein the multi-use sized container is selected from the group consisting of a gallon container, a half-gallon container, and a quart container.

21. The vending system of claim 14, wherein at least a portion of the product delivery path is gravity fed.

22. The vending system of claim 14, further comprising a freestanding structure enclosing the storage location and the product delivery path.

23. The vending system of claim 22, wherein the freestanding structure is in parking lot.

24. The vending system of claim 14, wherein the product delivery path comprises two or more product conveyors.
